(19) United States
(12) Patent Application Publication
(10) Pub. No.: US 2009/0192911 A1
(43) Pub. Date: Jul. 30, 2009

(54) PAYMENT REDIRECTION FOR ONLINE TRANSACTIONS

(75) Inventor: Patrick Graf, Bellair, FL (US)

Correspondence Address: MERCHANT & GOULD PC, P.O. BOX 2903, MINNEAPOLIS, MN, 55402-0903, US

(73) Assignee: REVOLUTION MONEY INC., St. Petersburg, FL (US)

(21) Appl. No.: 12/021,826

(22) Filed: Jan. 29, 2008

(51) Int. Cl. G06Q 30/00

(52) U.S. Cl. 705/26

(57) ABSTRACT

Methods and systems for facilitating an online value exchange transaction are disclosed. One method includes delivering a link for display by a service provider, the link affiliated with an exchange facilitator and unaffiliated with the service provider. The method further includes, upon selection of the link, redirecting a user of the service provider to the exchange facilitator. The method further includes receiving information regarding a value exchange between the user and a subscriber of the exchange facilitator. The method also includes requesting that the user accept one or more terms of the value exchange. The method includes performing an electronic transfer according to the one or more terms of the value exchange accepted by the user. Methods and systems for providing and obtaining payment are disclosed as well.

### TECHNICAL FIELD

The present disclosure relates to online payment mechanisms; in particular, the present disclosure relates to a payment redirection system for online transactions.

### BACKGROUND

Most online retailers depend on credit card companies for payment processing and management of payment systems. These retailers require customers to have a credit card to pay for goods and services purchased online. However, it is sometimes not feasible for online merchants, or sellers, to accept credit card payments. For example, low volume or low margin retailers, or sellers, often do not want to pay credit card processing fees if they can be avoided. Furthermore, in certain cases, retailers offering goods on third party websites, such as auction sites or resellers, do not regularly sell goods, and therefore do not have the business arrangements or economies of scale necessary to make credit card transactions possible. Furthermore, websites requiring certain types of credit cards can limit the universe of potential purchasers, because certain purchasers may not have the type of credit card accepted by the particular retailer.

More recently, certain companies have begun to pair with online retailers to perform simple money transfer tasks, thereby avoiding use of credit cards or other similar credit-based systems. In these companies' systems, a payment mechanism is integrated with and receives a variety of data from the seller's website, and allows a direct funds transfer between buyers and sellers. However, these companies' systems have disadvantages as well. For example, some of these systems require both the buyer and seller to be preregistered users of the payment mechanism. In other systems, the mechanism requires the permission of the host of the seller to incorporate that payment mechanism, even though the host's interests may not be compatible with the convenience of the buyer and the seller.

For these and other reasons, improvements are desirable.

### SUMMARY

In accordance with the present disclosure, the above and other problems are solved by the following:

In a first aspect, a method for facilitating an online value exchange transaction is disclosed. The method includes delivering a link for display by a service provider, the link affiliated with an exchange facilitator and unaffiliated with the service provider. The method further includes, upon selection of the link, redirecting a user of the service provider to the exchange facilitator. The method further includes receiving information regarding a value exchange between the user and a subscriber of the exchange facilitator. The method also includes requesting that the user accept one or more terms of the value exchange. The method includes performing an electronic transfer according to the one or more terms of the value exchange accepted by the user.

In a second aspect, a system for facilitating an online value exchange transaction is disclosed. The system includes a link delivery module that delivers a link for display by a service provider, the link affiliated with an exchange facilitator and unaffiliated with the service provider. The system also includes a redirection module that, upon selection of the link, redirects a user of the service provider to the exchange facilitator. The system includes an information collection module that receives information regarding a value exchange between the user and a subscriber of the exchange facilitator. The system also includes a request module that requests that the user accept one or more terms of the value exchange. The system further includes a transfer module that performs an electronic transfer according to the one or more terms of the value exchange accepted by the user.

In a third aspect, a method of obtaining payment in an online value exchange transaction is disclosed. The method includes subscribing to a service provided by an exchange facilitator for funds transfer. The method further includes assigning a link to a proposed transaction hosted by a service provider, the link affiliated with the exchange facilitator and unaffiliated with the service provider. The method also includes negotiating one or more terms of a value exchange via the exchange facilitator with a user of the service provider. The method also includes receiving a transfer of funds from the user via the exchange facilitator, the transfer of funds corresponding to the one or more terms of the value exchange.

### BRIEF DESCRIPTION OF THE DRAWINGS

FIG. 1 illustrates an example network in which aspects of the present disclosure can be implemented;

FIG. 2 is a flowchart of methods and systems for facilitating an online value exchange transaction, according to a possible embodiment of the present disclosure;

FIG. 3 is a flowchart of methods and systems for obtaining payment in an online value exchange transaction, according to a possible embodiment of the present disclosure;

FIG. 4 is a flowchart of methods and systems for executing an online value exchange transaction, according to a possible embodiment of the present disclosure;

FIG. 5 is an example embodiment of a schematic representation of a computing system that may be used to implement aspects of the present disclosure;

FIG. 6 is a schematic block diagram of a system for facilitating an online value exchange transaction, according to a particular embodiment of the present disclosure;

FIG. 7 is a user interface for an online value exchange transaction containing a link to an exchange facilitator, according to a possible embodiment of the present disclosure;

FIG. 8 is a user interface for entering user information for use by an exchange facilitator, according to a possible embodiment of the present disclosure;

FIG. 9 is an example user interface illustrating a message sent to a user containing a link connecting the user to a webpage of the exchange facilitator;

FIG. 10 is a user interface managed by an exchange facilitator and illustrating pending and negotiated transactions of a user, according to a possible embodiment of the present disclosure;

FIG. 11 is a user interface allowing the user to confirm processing of a transaction according to one or more terms of a value exchange transaction, according to a possible embodiment of the present disclosure; and

FIG. 12 is a user interface confirming processing of a transaction according to a possible embodiment of the present disclosure.

### DETAILED DESCRIPTION

Various embodiments of the present disclosure will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

In general, the present disclosure relates to methods and systems for facilitating an online value exchange transaction, from the various perspectives of a purchaser, a seller, and those accommodating the purchase or sale of goods or services. The methods and systems of the present disclosure generally provide a link for display by a service provider, with the link being affiliated with an exchange facilitator and unaffiliated with the service provider. The link redirects a user of the service provider to an exchange facilitator, such as a payment transfer service. Various other features are included in the methods and systems described herein.

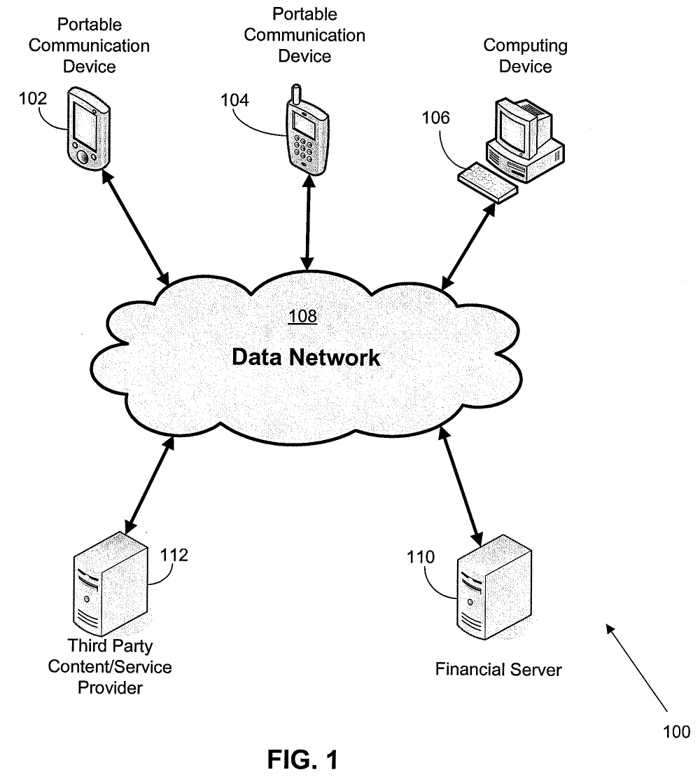

Referring now to FIG. 1, an example network 100 is shown, within which aspects of the present disclosure can be implemented. The network 100 includes a number of electronic devices, shown as devices 102, 104, 106. For example, the electronic devices 102, 104, 106 can be any of a number of types of personal computers, smartphones, portable computing devices with telecommunications capabilities, or handheld devices. Also note that electronic devices (also described herein as communications devices, generally) include, but are not limited to, personal digital assistants (PDA), computing systems, pocket personal computers (pocket PCs), MP3 players, set top boxes, and other such systems.

The electronic devices 102, 104 can be any of a number of types of devices capable of connecting to a data network 108, such as the internet. The data network 108 is a packet-based data network capable of sending and receiving digital data, such as the internet or some portion thereof. The data network 106 can operate on any of a number of protocols or file formats.

A financial server 110 and third party service provider 112 are also connected to the data network 108, and provide various services accessible to users of the electronic devices 102, 104, 106. For example, the financial server 110 provides money or other value exchange services to users of the network 100, such as for payment in exchange for goods or services. The financial server 110 can provide, in various embodiments, a direct user-to-user payment system in which money transfers and payment negotiation can take place without requiring use of a third party to route money transfers.

The third party service provider 112 provides a location at which any of a number of users can offer for sale a variety of goods or services. The third party service provider 112 can be an online retailer, or can be an online community in which individual users can offer goods or services for sale, such as an online auction site or sales bulletin board.

In certain instances, the third party service provider 112 does not have preset payment relationships with credit card companies or other value transfer services. In such instances, a user of the service provider 112 can place a link within the user's advertisement or display of goods or services, with the link able to redirect interested purchasers to a webpage managed by an exchange facilitator (e.g. the manager or provider of the financial server 110 for exchanging money/value for the goods and services).

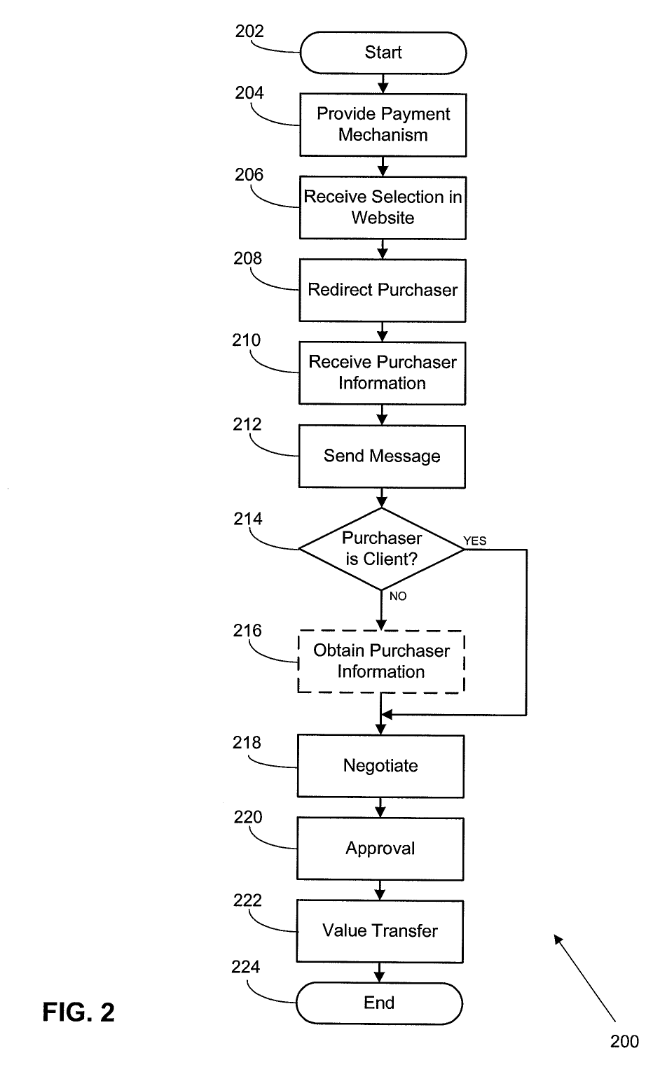

FIG. 2 is a flowchart of methods and systems for facilitating an online value exchange transaction, according to a possible embodiment of the present disclosure. The methods and systems 200 shown correspond to operations of an exchange facilitator, such as an online auction site or bulletin board service, to enable purchasers (i.e. purchasing users) and sellers (i.e. selling users) to directly transfer value in any of a number of types of online transactions. In various embodiments, the selling user in the system corresponds to an online retailer or other merchant, or can be an individual user selling items using a third party service provider operating a bulletin board system or online auction site.

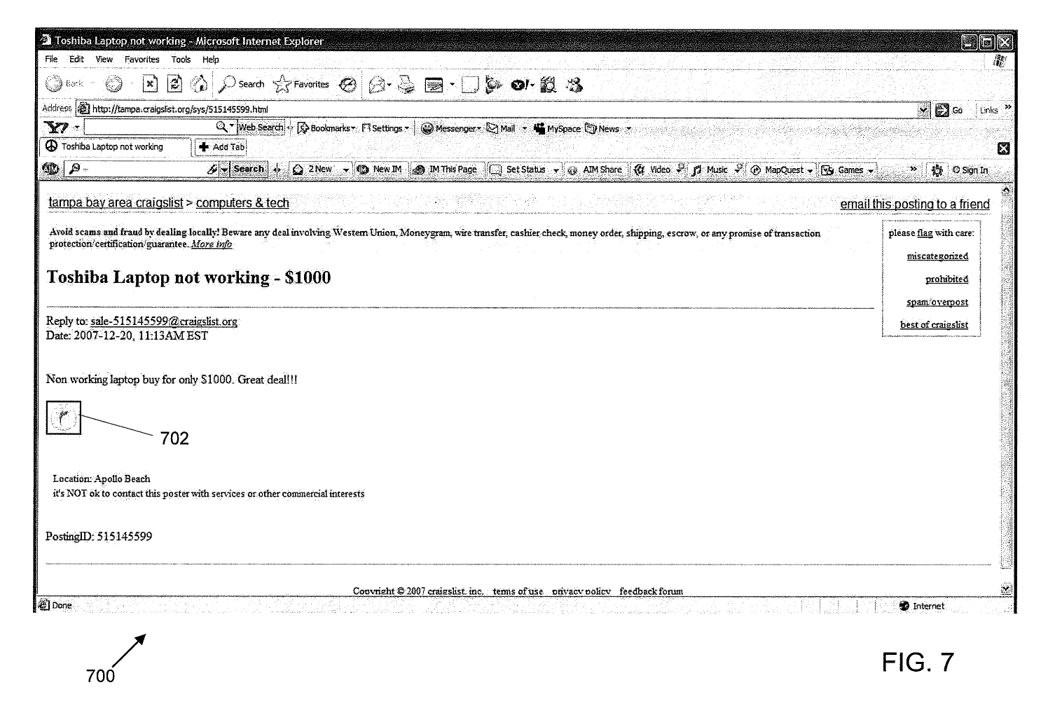

The system 200 is instantiated at a start operation 202, which corresponds with a seller initially setting up a page displaying the goods/services that are for sale. Operational flow proceeds to a provide payment mechanism module 204. The provide payment mechanism module 204 provides a link, such as a graphic or text link, for display in a webpage alongside the goods/services that are for sale. The exchange facilitator can provide the link, for example, by hosting a referenced graphic that is displayed as part of a webpage, or can host the target of the link. An example of such a graphic is shown in FIG. 7.

Operational flow proceeds to a receive selection module 206. The receive selection module 206 corresponds to a determination that a purchasing user (i.e. a prospective purchaser) has clicked on the link that is provided in conjunction with a specific good or service. The receive selection module 206 may or may not be performed by software managed by the exchange facilitator; in various embodiments, the exchange facilitator or a third party service provider provides code that receives an indication that the link has been selected.

Operational flow proceeds to a redirection module 208. The redirection module 208 redirects the purchasing user from a webpage related to offered goods/services, such as could be hosted by a third party service provider (e.g. the provider 112 of FIG. 1) to a webpage provided by a value exchange facilitator, such as the financial server 110 of FIG. 1. In certain embodiments, the redirection module 208 operates in response to detection of a link activation/selection as would be determined in the receive selection module 206.

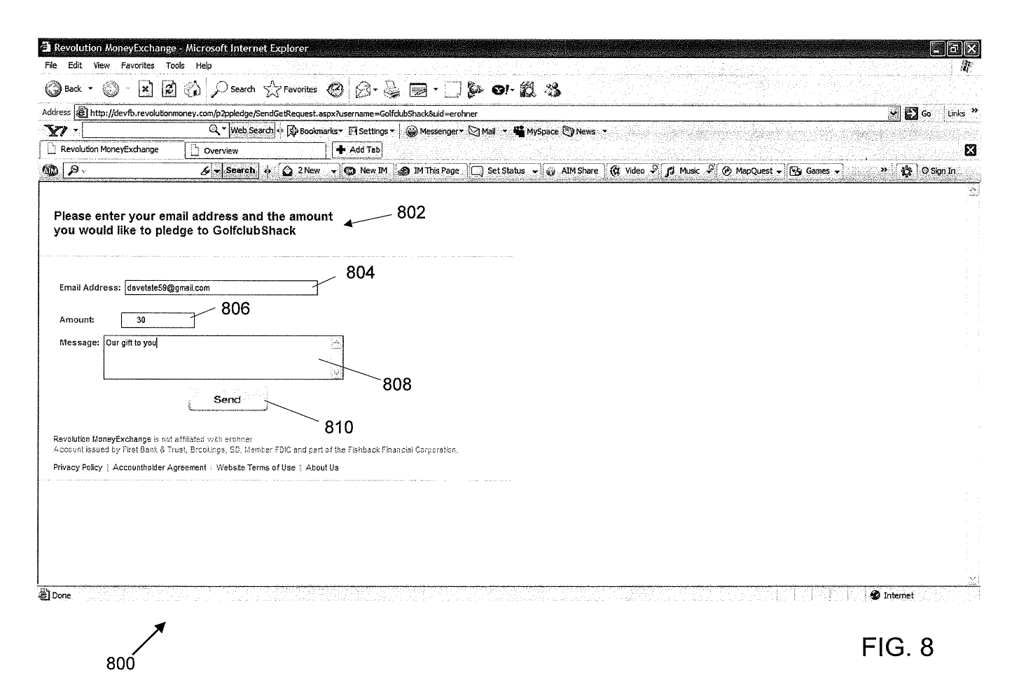

Operational flow proceeds to a purchaser information module 210, which corresponds to display of a webpage requesting information from a user that is redirected to that webpage by the redirection module 208, and subsequent collection of information from that purchasing user that will be used to facilitate the value exchange transaction. An example of such a webpage is shown in FIG. 8. Preferably, as can be seen in that example figure, the purchaser information module 210 collects a variety of information, including contact information (email address, mail address, etc.) of the purchasing user, as well as the value to be transferred in exchange for the goods/services to which the value exchange relates. A customized message from the purchasing user can be included in the information collected by the purchaser information module 210 as well.

Operational flow proceeds to a message module 212, which sends a message to the purchasing user based on the information received in the purchaser information module 210. The message sent using the message module 212 provides the user (purchaser) with a variety of information relating to completion of the value exchange transaction. For example, the purchasing user can be presented with the identity of the selling user, who is generally a preregistered subscriber to the exchange facilitator's service. The purchasing user can also be presented with the amount requested (drawn from either the original website displaying the goods/services or from information provided by the purchasing user during the purchase information module 210). The purchasing user is generally also presented with a link that leads that user to a webpage that allows for negotiation and completion of the value exchange transaction.

By using a link in a subsequent message, the system 200 provides a level of protection to ensure that the purchasing user (i.e. the user sitting at a computing system) is in fact the person who will pay for the goods/services. Specifically, the system 200 ensures that the purchaser has access to an email account associated with the user (who is presumably him/herself), as well as that user's financial information necessary to complete the transaction.

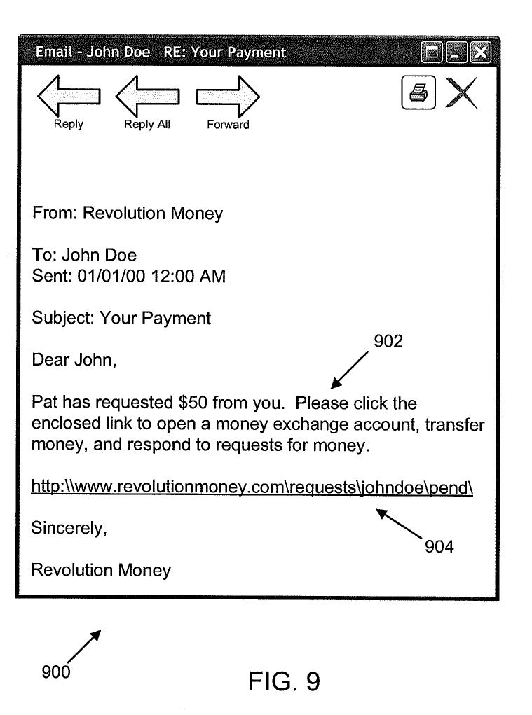

In certain embodiments, the message can be presented to the purchasing user as an email sent to that user's email account, the address for which was provided by the user during operation of the purchaser information module 210. An example of such a message is shown in FIG. 9. In further embodiments, the message can be presented to the user as a pop-up window allowing the user to view the information displayed and select the link to proceed with the value exchange transaction.

In typical embodiments of the present disclosure, the selling user is a preregistered subscriber to the exchange facilitator, while the purchasing user may or may not be a preregistered subscriber to the exchange facilitator. Operational flow proceeds to a client determination operation 214, which corresponds with the exchange facilitator determining, based on the information collected from the purchasing user, whether that purchasing user is a preregistered subscriber to the services of the exchange facilitator. If the purchasing user is already a subscribing user, then the exchange facilitator will have various information available to it regarding the user, including an account with finds available for exchange. If the purchasing user is not already a subscribing user, then the exchange facilitator will generally need to obtain access to something of value for performing the exchange (e.g. access to a bank account or creation of a bank or credit account). Therefore, if the user is not preregistered with the exchange facilitator, operational flow branches “no” to an account information module 216. If the user is preregistered, operational flow branches “yes” to a negotiation module 218, operation of which is described below.

The account information module 216 requests and acquires information from the purchasing user that is necessary to route funds between the users to accomplish the value exchange. For example, the account information module can request from the user information relating to setting up an account for funds transfer with the value exchange facilitator, or to link another existing bank account for access by the exchange facilitator. This may include account numbers, security information, and other information. Additional validation steps may be incorporated into the account information module 216 as well, such as providing usernames, passwords, pin numbers, or other account validation information that can assist in ensuring that the person seeking to use funds is in fact the person who owns/controls those funds (identity validation). Various other types of account management and preference-setting options can also be presented to a user who is attempting to subscribe to the value exchange facilitator's service.

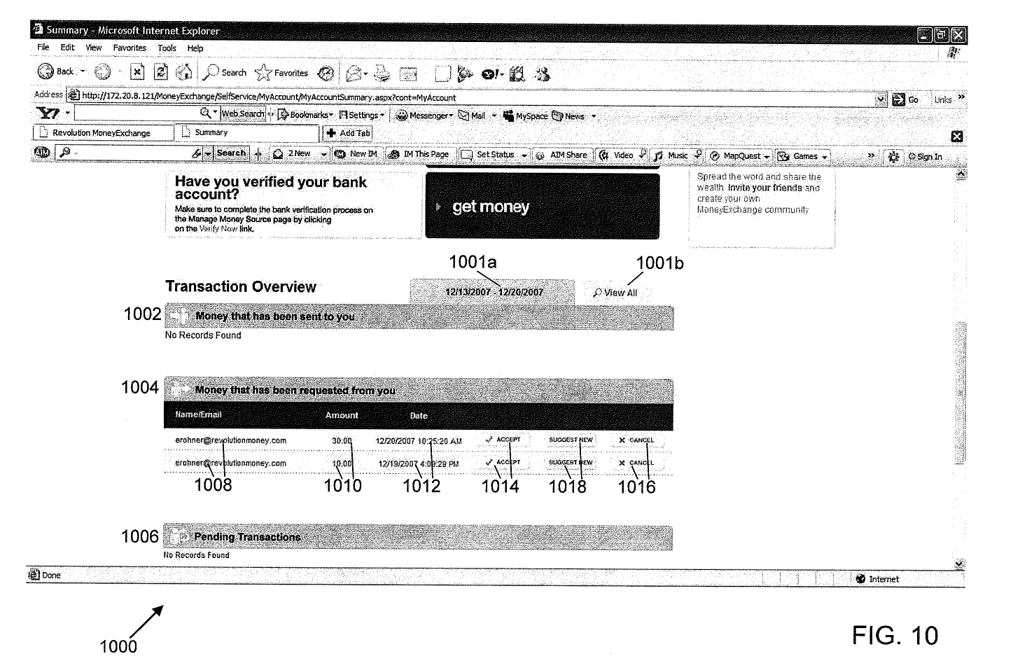

Operational flow proceeds from the account information module 216 (or from the client determination operation 214) to a negotiation module 218. The negotiation module 218 allows the purchasing user to negotiate one or more terms of a value transfer transaction. For example, the negotiation module 218 may simply provide an opportunity for the purchasing user to make a revised counteroffer having different terms than are currently proposed, as drawn from the information provided by that user, from the seller, or from a third party service provider. The different terms can include, for example, a higher or lower price than is reported to the value exchange facilitator. An example of a webpage in which such negotiation can be initiated is shown in FIG. 10.

Operational flow proceeds from the negotiation module 218 to an approval module 220. The approval module corresponds to receipt of approval of the terms of the value exchange transaction from one or both of the purchasing user and the selling user (preregistered subscriber). The approval module 220 typically receives approval from both parties; however, in certain embodiments in which the selling user indicates the acceptability of certain prices, no further approval need be received from that user if a purchasing user's price and other terms fall within the selling user's preset bounds of acceptability.

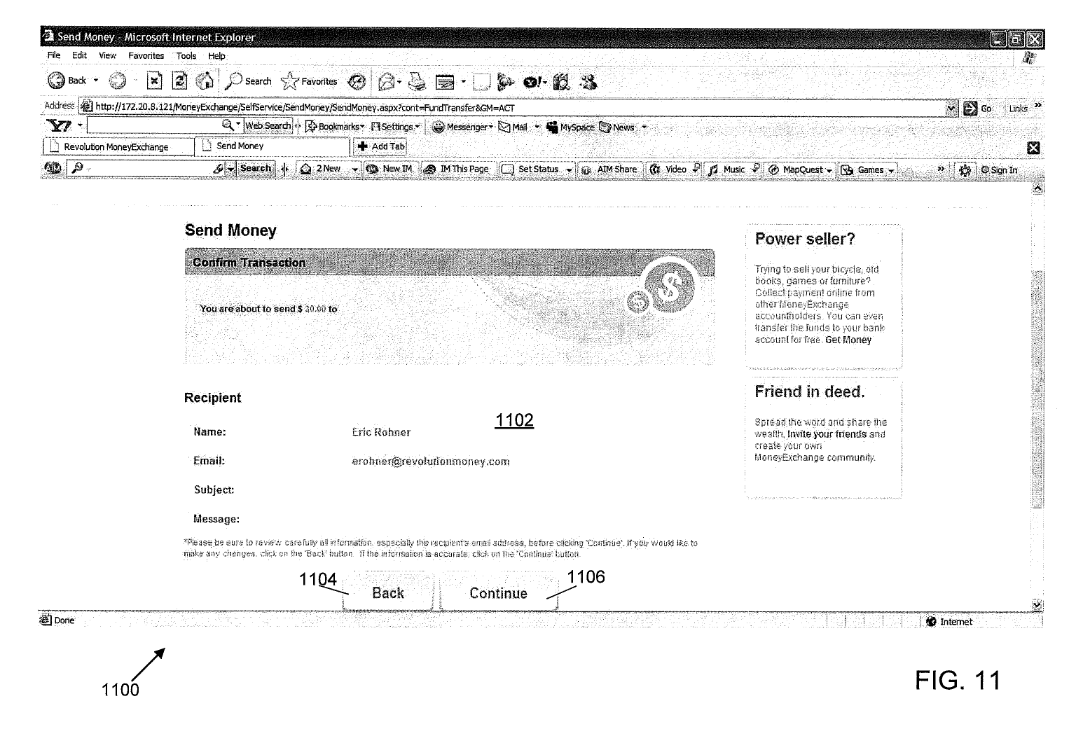

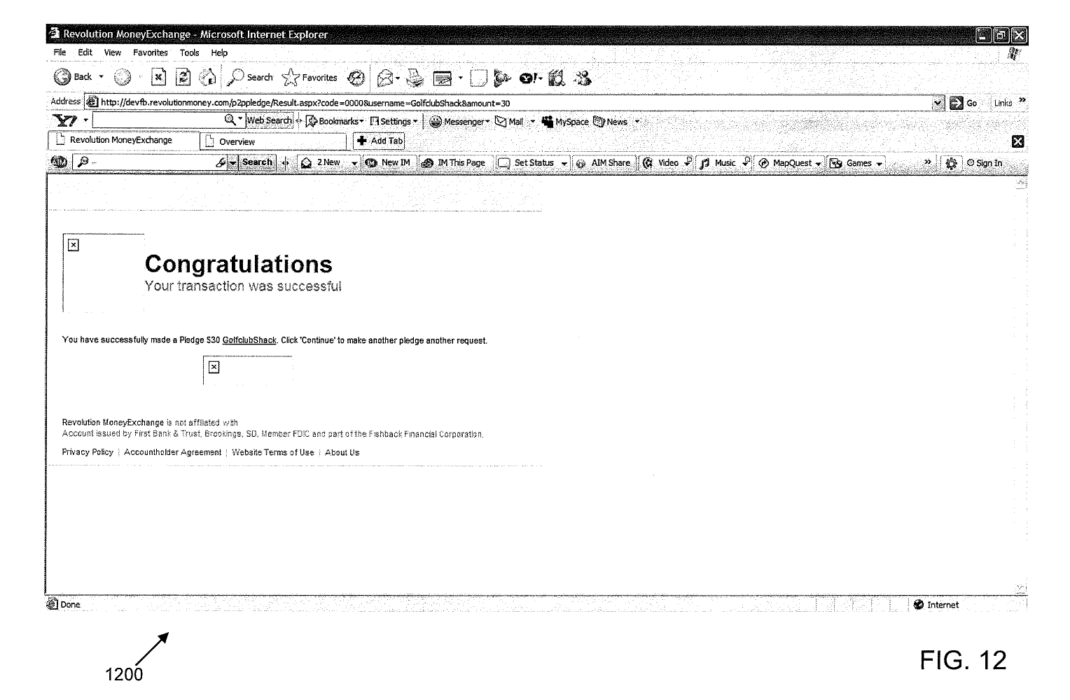

Operational flow proceeds from the approval module to a value transfer module 222. The value transfer module 222 corresponds to the exchange facilitator proceeding to exchange value (e.g. funds, other valuable items) according to the one or more terms agreed upon between the user and the seller. Examples of webpages requesting and confirming such a value transfer are shown in FIG. 11-12. Operational flow terminates at an end operation 224, which corresponds with completion of the value exchange transaction.

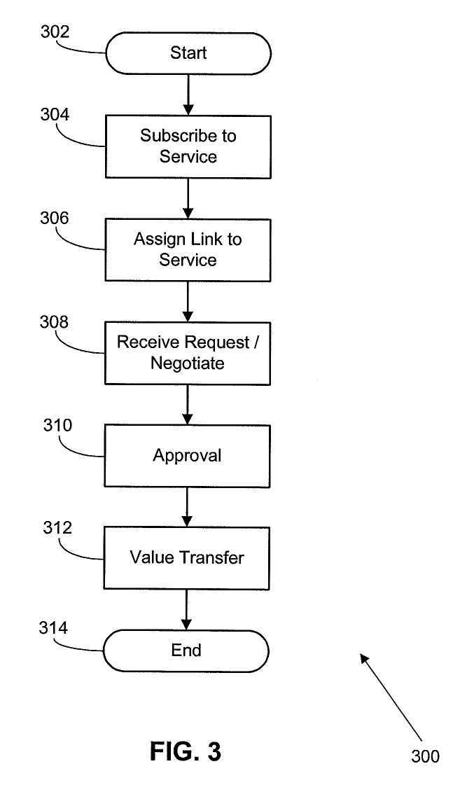

FIG. 3 is a flowchart of methods and systems for obtaining payment in an online value exchange transaction, according to a possible embodiment of the present disclosure. The methods and systems 300 as shown are generally performed by a seller of goods or services who may or may not have full content and payment mechanism control over the domain or website in which their products or services are sold. Operational flow within the system 300 is instantiated at a start operation 302, which generally corresponds to the seller beginning to sell goods or services online; however, certain of the modules (e.g. the subscribe module 304, below) can be performed/executed prior to actual sales by the seller.

Operational flow proceeds to a subscribe module 304. The subscribe module 304 corresponds to the seller becoming a subscriber to the value exchange services performed by an exchange facilitator, such as a company or institution managing the financial server of FIG. 1. The subscribe module 304 generally requests the same type of information as the account information module 216 of FIG. 2, which in effect subscribes a non-preregistered purchasing user with the services of the exchange facilitator.

Operational flow proceeds to a link module 306. The link module 306 corresponds to providing a link in conjunction with an offer for sale of goods or services. A selling user can provide the link by, for example, placing code in the body of an advertisement that would cause a button or link to appear alongside that advertisement when displayed to a user. In one possible embodiment, the link module corresponds to the seller incorporating a link having a graphic hosted by the exchange facilitator.

Operational flow proceeds to a transaction module 308. The transaction module 308 corresponds to executing a value exchange transaction with a purchasing user, including performing a variety of optional negotiation steps in an attempt to arrive at agreed upon terms for the value exchange. For example, the transaction module 308 can correspond to receiving a counter proposal on a price for goods, and a subsequent negotiation process between the purchasing user and the selling user. Or the transaction module 308 can correspond to allowing the purchasing and selling user an opportunity to negotiate, whether or not such negotiation actually takes place.

Operational flow proceeds to an approval module 310, which corresponds to the selling user indicating acceptance of the proposed terms of the value exchange. The proposed terms of the value exchange are typically stated in conjunction with the online display of goods or services for sale, and therefore require little or no additional input from the selling user (in that all of the selling user's essential offer terms were met by the purchasing user); therefore, as previously mentioned, negotiation may or may not occur prior to approval by the seller.

Operational flow proceeds to a transfer module 312. The transfer module 312 generally corresponds to receipt of funds by the selling user, such as through execution of a transfer of funds or other items of value as would occur in the value transfer module 222 of FIG. 2, above. Operational flow terminates at an end operation 314, which signifies a completed value exchange transaction.

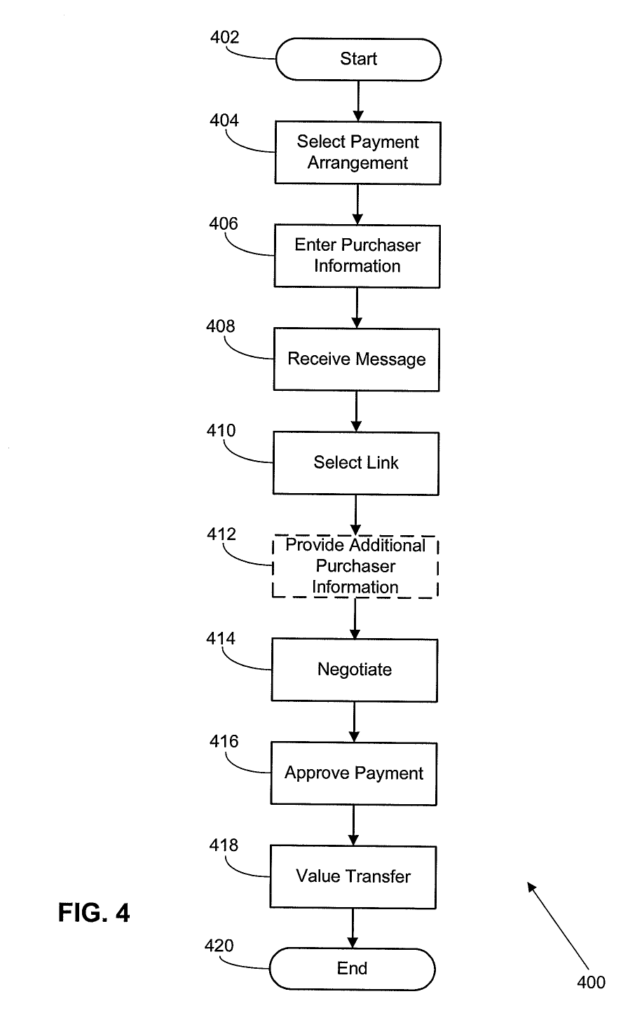

FIG. 4 is a flowchart of methods and systems for executing an online value exchange transaction, according to a possible embodiment of the present disclosure. The methods and systems 400 as shown generally correspond to the steps a purchaser (i.e. purchasing user) would take when purchasing goods or services online and using an exchange facilitator in a manner contemplated by the present disclosure. Operational flow within the system 400 is instantiated at a start operation 402, which generally occurs at a time corresponding to a user searching online for desired goods/services.

Operational flow proceeds to a selection module 404, which corresponds to selection of a link to an exchange facilitator. The selection module 404 can correspond to purchasing user's selection of an embedded hyperlink placed in a webpage alongside an advertisement for a product or service. The link includes information relating to both the identity of the exchange facilitator and the identity of the selling user, such that the prospective purchaser selecting the link need not determine which entity to negotiate or otherwise transact business with. The link also optionally obtains information from the webpage or selling user relating to the selling user's asking price for the goods/services.

Operational flow proceeds to a purchaser information module 406. The purchaser information module 406 corresponds to entry of information into a webpage by the purchasing user according to specific requests of the exchange facilitator. In various embodiments, the purchaser information module 406 corresponds to entry of information by the purchasing user in response to execution of the purchase information module 210 of FIG. 2, above. An example form in which the purchasing user will enter information is shown in FIG. 8.

Operational flow proceeds to a receive message module 408. The receive message module 408 corresponds to the purchasing user receiving a message, such as the message shown in FIG. 9. The message generally includes instructions and a link, the instructions telling the purchasing user to select the link to direct the user to the website of the exchange facilitator where further processing and finalization of the value exchange transaction can occur. Operational flow proceeds to a link selection module 410. The link selection module 410 corresponds to the purchasing user selecting the link embedded in the message received.

Operational flow proceeds to an optional additional purchaser information module 412. The additional purchaser information module 412 corresponds to the purchasing user providing additional information to the exchange facilitator, such as in response to operation of the module 216 of FIG. 2. Through this process, the purchasing user becomes a subscriber to the services provided by the exchange facilitator if he or she is not already a subscriber.

Operational flow proceeds to a negotiation module 414, which corresponds to the purchasing user choosing to negotiate one or more terms of a value exchange transaction, such as price, quantity, etc. The negotiation module 414 corresponds to user interaction with the negotiation module 218 of FIG. 2. In certain embodiments, the negotiation module 414 can be the purchasing user's response to the selling user's negotiation referenced in the transaction module 308 of FIG. 3. In further embodiments, the negotiation module 414 corresponds to the purchasing user initiating a negotiation process with the selling user, such as by choosing to alter one or more terms of the proposed value exchange transaction.

Operational flow proceeds to an approval module 416, which corresponds to agreement with the current terms of the value exchange transaction on the part of the purchasing user. A user interface with which a purchasing user can signify approval with the terms of a value exchange transaction is shown in FIG. 11.

Operational flow proceeds to a value transfer operation 418, which corresponds to transfer of funds from the purchasing user to the selling user through use of the accounts set up for the users (now both subscribers to the exchange facilitator's service). Operational flow terminates at an end operation 420, corresponding to completion of the transaction. A user interface signifying completion of the transaction is shown in FIG. 12.

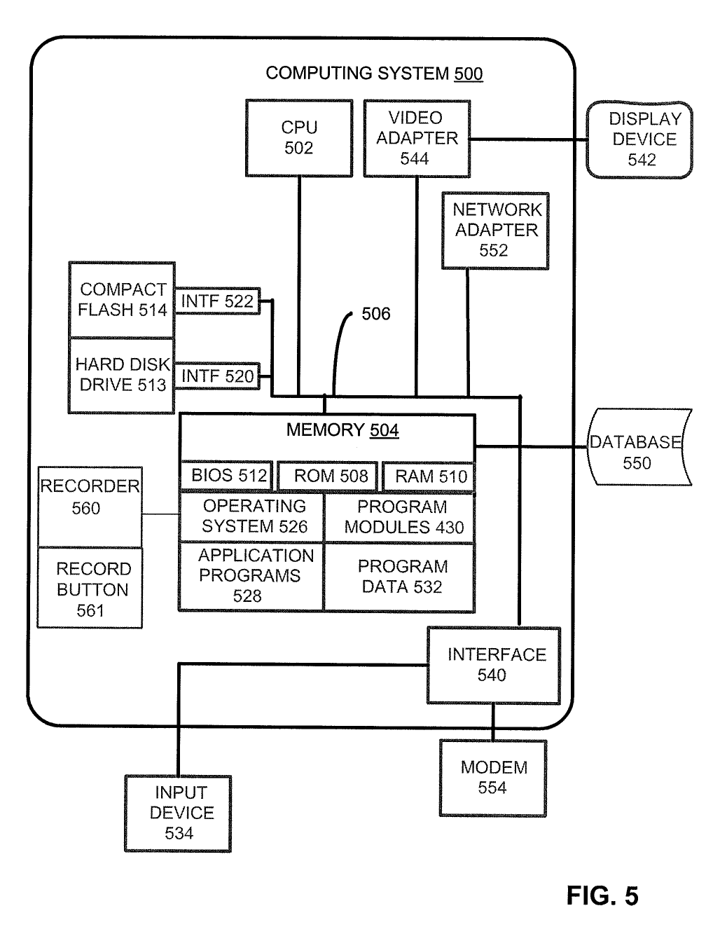

Referring to FIG. 5, an exemplary environment for implementing embodiments of the present disclosure includes a general purpose computing device in the form of a computing system 500, including at least one processing system 502. In the various embodiments described herein, the general purpose computing device can correspond to the various computing devices of FIG. 1, such as the electronic devices, the financial server, or the third party service provider. A variety of processing units 502 are available from a variety of manufacturers, for example, Intel or Advanced Micro Devices. The computing system 500 also includes a system memory 504, and a system bus 506 that couples various system components including the system memory 504 to the processing unit 502. The system bus 506 might be any of several types of bus structures including a memory bus, or memory controller; a peripheral bus; and a local bus using any of a variety of bus architectures.

Preferably, the system memory 504 includes read only memory (ROM) 508 and random access memory (RAM) 510. A basic input/output system 512 (BIOS), containing the basic routines that help transfer information between elements within the computing system 500, such as during start up, is typically stored in the ROM 508.

Preferably, the computing system 500 further includes a secondary storage device 513, such as a hard disk drive, for reading from and writing to a hard disk (not shown), and/or a compact flash card 514.

The hard disk drive 513 and compact flash card 514 are connected to the system bus 506 by a hard disk drive interface 520 and a compact flash card interface 522, respectively. The drives and cards and their associated computer readable media provide nonvolatile storage of computer readable instructions, data structures, program modules and other data for the computing system 500.

Although the exemplary environment described herein employs a hard disk drive 513 and a compact flash card 514, it should be appreciated by those skilled in the art that other types of computer-readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), read only memories (ROMs), and the like.

A number of program modules may be stored on the hard disk 513, compact flash card 514, ROM 508, or RAM 510, including an operating system 526, one or more application programs 528, other program modules 530, and program data 532. A user may enter commands and information into the computing system 500 through an input device 534. Examples of input devices might include a keyboard, mouse, microphone, joystick, game pad, satellite dish, scanner, digital camera, touch screen, and a telephone. These and other input devices are often connected to the processing unit 502 through an interface 540 that is coupled to the system bus 506. These input devices also might be connected by any number of interfaces, such as a parallel port, serial port, game port, or a universal serial bus (USB). A display device 542, such as a monitor or touch screen LCD panel, is also connected to the system bus 506 via an interface, such as a video adapter 544. The display device 542 might be internal or external. In addition to the display device 542, computing systems, in general, typically include other peripheral devices (not shown), such as speakers, printers, and palm devices.

When used in a LAN networking environment, the computing system 500 is connected to the local network through a network interface or adapter 552. When used in a WAN networking environment, such as the Internet, the computing system 500 typically includes a modem 554 or other means, such as a direct connection, for establishing communications over the wide area network. The modem 554, which can be internal or external, is connected to the system bus 506 via the interface 540. In a networked environment, program modules depicted relative to the computing system 500, or portions thereof, may be stored in a remote memory storage device. It will be appreciated that the network connections shown are exemplary and other means of establishing a communications link between the computing systems may be used.

The computing system 500 might also include a recorder 560 connected to the memory 504. The recorder 560 includes a microphone for receiving sound input and is in communication with the memory 504 for buffering and storing the sound input. Preferably, the recorder 560 also includes a record button 561 for activating the microphone and communicating the sound input to the memory 504.

A computing device, such as computing system 500, typically includes at least some form of computer-readable media. Computer readable media can be any available media that can be accessed by the computing system 500. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 500.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

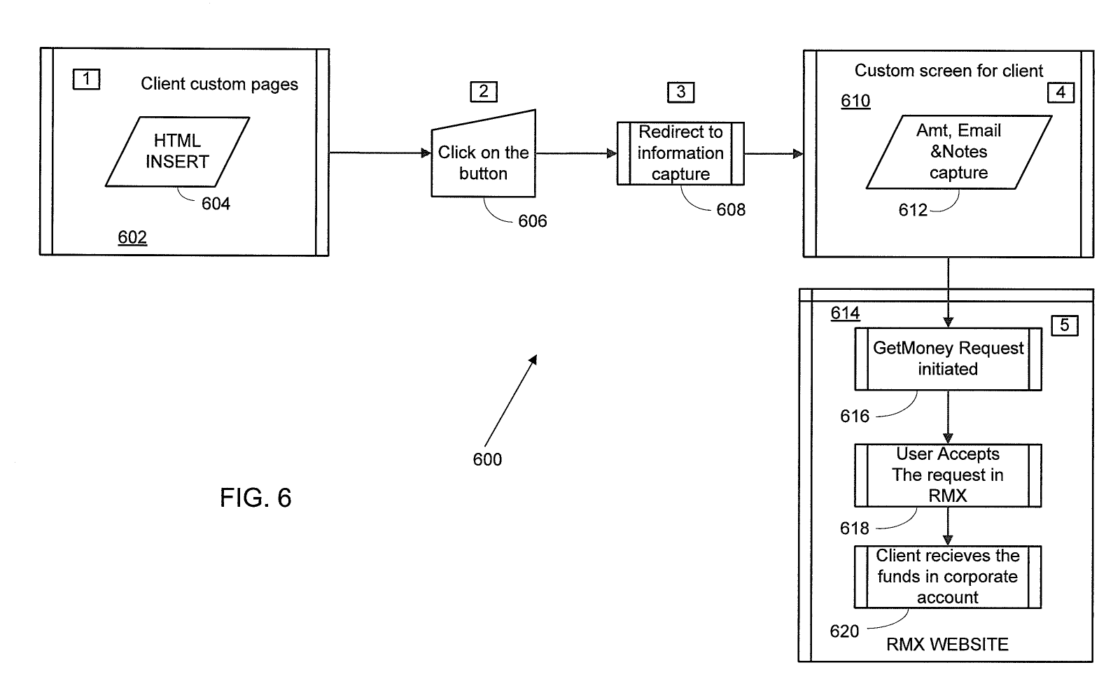

FIG. 6 is a schematic block diagram of a system for facilitating an online value exchange transaction, according to a particular embodiment of the present disclosure. The system 600 operates generally within the network 100 of FIG. 1, and illustrates interactions between various users, including purchasing and selling users of goods and services, as well as value exchange facilitators such as financial services companies, and other online service providers, such as bulletin board moderators and online auction sites. The system 600 generally allows selling users to provide a link in conjunction with a proposed sale of a good or service that can redirect a user toward a value exchange facilitator with whom the selling user has a preexisting relationship.

The system 600 includes various client custom pages 602, certain ones of which include a code insert 604. Each client custom page 602 corresponds to an offer for one or more products or services, and can be in the form of an advertisement, auction, or other type of generalized offer for sale. The code insert 604 corresponds to certain client custom pages, and connects the specific product or service with a method of payment by direct value transfer between a buyer and seller. The code insert 604 can cause a link to appear in the selected client custom page 602, and can be embodied in an image or text. Code for the insert 604 could be in HTML, as shown in the figure; however Java, AJAX, or other languages could be used. In the case of HTML, an example code snippet enabling such a link using an image could be:

<!DOCTYPE html PUBLIC “-//W3C//DTD XHTML 1.0
Transitional//EN”
“http://www.w3.org/TR/xhtml1/DTD/xhtml1-transitional.dtd”>
<html xmlns=“http://www.w3.org/1999/xhtml” >
<head>
<title>R</title>
</head>
<body>
<a href=“SendGetRequest.aspx?username=GolfclubShack&uid=erohner”
target=‘_self’><img
src=“http://devfb.revolutionmoney.com/P2PPledge/images/icon_big2.jpg”
alt=“”/></a>
</body>
</html>

As can be seen in the above code, a link to an image is created and that image is itself a hyperlink to a user viewing the webpage. An example of the appearance of a widget created using this type of code is shown in FIG. 7, below. Of course, other code could be used as well, consistent with the principles of the present disclosure.

A selection operation 606 corresponds to a purchasing user clicking on the button or link provided by the code insert 604. A redirection operation 608 executes following the selection operation 606, and corresponds to redirecting the purchasing user away from the client custom pages 602 to a customized client screen 610. The customized client screen 610 provides a user interface that includes a capture module 612 which captures information from the purchasing user including the agreed-upon price of the goods or services displayed on the client custom pages 602, and contact information from the user.

A remote money exchange website 614 provides functionality to complete the value exchange transaction for the goods or services viewed in the client custom pages 602. The remote money exchange website 614 includes a request operation 616, an acceptance operation 618, and a fund transfer operation 620. The request operation 616 initiates a request for funds from the purchasing user. The request operation 616 uses information gathered from the purchasing user via the capture module 612, and inputs that information into a pending request for funds from the selling user, such that the purchasing user must accept that request. A number of pending requests are shown in FIG. 10. The acceptance operation 618 provides a further webpage allowing the user to confirm that the terms of the pending request are agreed upon (or, alternatively, that the terms are not acceptable and that the purchasing user chooses to negotiate one or more of the terms of the value exchange, as previously explained). Once the value exchange is deemed acceptable by both parties, the fund transfer operation 620 transfers funds from the purchasing user to the selling user (i.e. the preexisting subscriber to the service).

Referring now to FIG. 7-12, various user interfaces are shown that illustrate example functionality and example data requests of purchasing and selling users, as well as functionality of a value exchange facilitator, according to a possible embodiment of the present disclosure.

FIG. 7 shows an example user interface 700 for an online value exchange transaction posted on a third party service provider and containing a link to an exchange facilitator. The user interface 700 generally corresponds to a webpage presented in a browser window (of any of a number of typical browsers, including Microsoft's Internet Explorer, Mozilla Firefox, Opera, or other browsers), and is generated by a third party service provider in which a user of that third party service provider can post messages offering to buy or sell goods and services. In the embodiment shown, the user interface 700 allows selling users to post custom messages related to the goods and services concerned, creating a custom client webpage for each item or service offered. The user interface 700 includes a link 702, shown as an image, which provides for redirection away from the third party service provider and to a value exchange facilitator for completing the transaction as described in the webpage.

FIG. 8 shows an example user interface 800 for entering user information for use by an exchange facilitator. The user interface 800 is illustrated as appearing in a typical browser window and can be reached, for example, by selection of the link 702 in the user interface 700 of FIG. 7. The user interface 800 includes a message 802 indicating to a view of that interface the identity of the party (e.g. the selling user) with whom a value exchange is being transacted. In the embodiment shown, it can be seen that the entity “GolfClubShack” is the entity seeking payment. The user interface 800 includes a variety of information request fields, including an email address field 804, an amount field 806, and a message field 808. A purchasing user enters appropriate information into each of these fields (e.g. a valid email address in the email address field 804, the amount requested for the item/service in the amount field 806, and an optional message in the message field 808). A send button 810 allows the purchasing user to indicate that the information in the fields 804, 806, 808 is complete and to submit that information for processing by the exchange facilitator.

FIG. 9 shows a user interface 900 illustrating an example message sent to a user allowing the user to confirm and accept a value exchange request (e.g. a payment request). The user interface 900 represents a typical email client application in which a message can be viewed. The user interface 900 includes a message 902, which provides details and instructions to the recipient of the message regarding a pending value exchange request (funds transfer). The message 902 is generally addressed to a purchasing user of an item or service, and both includes the identity of the selling user and displays the price that was previously provided to the exchange facilitator (such as by a user through a different user interface, an example of which is shown in FIG. 8, above). The message also includes a link 904, which is selected by the recipient (the purchasing user) to complete the value exchange process. By sending the purchasing user an email message, the exchange facilitator can validate the identity of the purchasing party.

FIG. 10 shows an example user interface 1000 managed by an exchange facilitator and illustrating pending and negotiated transactions of various users of the exchange facilitator's service. The user interface 1000 is generally presented to both purchasing users and selling users to allow those users to manage various account transactions using the exchange facilitator. The user interface 1000 is generally presented in a browser window, and can be delivered from a server managed by a value exchange facilitator (e.g. the financial server 110 of FIG. 1).

In the embodiment shown, the user interface 1000 shows pending and completed transactions occurring in a predetermined timeframe. The user interface includes tabs 1001a-b allowing a user to select either the current period (a week, as shown, but possible a day, month, or year) or to select all transactions available.

The user interface 1000 illustrates a listing of the various types of transactions performed by the user, including a funds receipt listing 1002, pending requests listing 1004, and pending transaction listing 1006. Funds receipt listings 1002 corresponds to funds which have been received by the user from transactions in which that user was a selling user. Pending requests in the pending request listing 1004 correspond to transactions in which the user is a purchasing user and another subscriber (i.e. a selling user) is requesting payment. Pending transactions in the pending transactions listing 1006 correspond to requests for funds which have not yet been approved, such as in the instance where the user is a selling user requesting payment. In the embodiment shown, only pending requests have occurred with respect to the current user in the time period shown; it can be inferred that in the example shown, the user logged in to the exchange facilitator's service is a purchasing user.

Each pending request in the pending request listing 1004 can be accepted, rejected, or negotiated by the (purchasing) user. Each pending request includes various details in column format regarding the value exchange request (i.e. funds request in the embodiment shown), including a name of a requesting party 1008, an amount requested 1010, and timing information 1012. Command buttons associated with each request include an accept button 1014, a cancel button 1016, and a negotiate button 1018 (labeled as “suggest new”).

The accept button 1014 allows the purchasing user to accept the transaction based on the details presented in fields 1008-1012, which allows the exchange facilitator to process the value exchange (e.g. funds transfer) and remove the pending request from the pending request listing 1004. The cancel button 1016 cancels the transaction, deleting the transaction from the listing of pending requests 1004. The negotiate button 1018 leads the purchasing user to a further user interface (not shown) in which one or more terms can be modified and proposed to the requesting party (the selling user) as indicated in the requesting party field 1008.

In certain embodiments, the user interface 1000 is displayed to a purchasing user having pending requests for fund transfers who may or may not already be a preregistered subscriber to the exchange facilitator's service. In the instance that a link, such as the link 904 of FIG. 9, is followed by a non-subscribing purchasing user, that user may need to be routed to a different user interface (not shown) prior to display of the user interface 1000, for collection of information and registration/subscription of that purchasing user.

FIG. 11 shows an example user interface 1100 allowing the purchasing user to confirm processing of a transaction according to one or more terms of a value exchange transaction. The user interface 1100 can be, in certain embodiments of the present disclosure, the interface displayed upon selection of the accept button 1014 of FIG. 10, above, with respect to a given transaction. The user interface 1100 provides the purchasing user with a final review of the terms of the value exchange in a details field 1102, which lists the name, email address, subject, message, and amount of money to be transferred in the transaction. A back button 1104 allows the purchasing user to cancel the transaction at this stage, returning that user to a user interface, such as the user interface 1000, which displays the status of all of that user's pending or recent transactions. A continue button 1106 allows the purchasing user to confirm that he/she agrees with the terms of the transaction (parties, price, etc.) and triggers the exchange facilitator to proceed with the transaction.

FIG. 12 displays an example user interface 1200 confirming processing of a transaction. The user interface 1200 presents a message to the purchasing user indicating that the value exchange transaction has successfully taken place. The user interface 1200 can optionally present confirmation information to the user, such as a transaction identifier, an indication of a new balance in an account related to the exchange facilitator, or other information. The user interface 1200 can be presented to a user of a system, for example, by providing it to a computing system such as the systems 102-106 from a financial server 110 of FIG. 1.

Although the user interfaces of FIGS. 7-12 are described primarily with respect to display to a purchasing user, analogous user interfaces may be provided to allow for multi-way negotiation among purchasing users and selling users. The particular interfaces displayed merely provide an example of possible functionality that can be included in a system provided by an exchange facilitator.

The above specification, examples and data provide a complete description of the manufacture and use of the composition of the invention. Since many embodiments of the invention can be made without departing from the spirit and scope of the invention, the invention resides in the claims hereinafter appended.

1. A method of facilitating an online value exchange transaction, the method comprising:
delivering a link for display by a service provider, the link affiliated with an exchange facilitator and unaffiliated with the service provider;
upon selection of the link, redirecting a user of the service provider to the exchange facilitator;
receiving information regarding a value exchange between the user and a subscriber of the exchange facilitator;
requesting that the user accept one or more terms of the value exchange;
performing an electronic transfer according to the one or more terms of the value exchange accepted by the user.

2. The method of claim 1, wherein the subscriber is an online retailer.

3. The method of claim 1, wherein the one or more terms of the value exchange includes a price term.

4. The method of claim 1, further comprising providing negotiation capabilities to the user relating to the one or more terms of the value exchange.

5. The method of claim 1, further comprising determining whether the user is a subscriber of the exchange facilitator.

6. The method of claim 5, further comprising, upon determining that the user is not a subscriber of the exchange facilitator, obtaining additional information regarding the user.

7. The method of claim 6, wherein obtaining additional information includes obtaining bank account information.

8. The method of claim 6, wherein obtaining additional information comprises subscribing the user to the exchange facilitator.

9. The method of claim 1, wherein performing an electronic transfer comprises transferring funds from the user to the subscriber.

10. The method of claim 1, wherein the link is selected by the subscriber for display to the user.

11. A system for facilitating an online value exchange transaction, the system comprising:
a link delivery module that delivers a link for display by a service provider, the link affiliated with an exchange facilitator and unaffiliated with the service provider;
a redirection module that, upon selection of the link, redirects a user of the service provider to the exchange facilitator;
an information collection module that receives information regarding a value exchange between the user and a subscriber of the exchange facilitator;
a request module that requests that the user accept one or more terms of the value exchange; and
a transfer module that performs an electronic transfer according to the one or more terms of the value exchange accepted by the user.

12. The system of claim 11, wherein one or more of the modules execute on a financial server.

13. The system of claim 11, wherein the service provider is an online sales management system.

14. The system of claim 11, wherein the one or more terms of the value exchange includes a price term.

15. The system of claim 11, wherein the transfer module transfers funds from the user to the subscriber.

16. The system of claim 11, wherein the subscriber is an online retailer.

17. A method of obtaining payment in an online value exchange transaction, the method comprising:
subscribing to a service provided by an exchange facilitator for funds transfer;
assigning a link to a proposed transaction hosted by a service provider, the link affiliated with the exchange facilitator and unaffiliated with the service provider;
negotiating one or more terms of a value exchange via the exchange facilitator with a user of the service provider; and
receiving a transfer of funds from the user via the exchange facilitator, the transfer of funds corresponding to the one or more terms of the value exchange.

18. The method of claim 17, wherein the service provider is an online auction website.

19. The method of claim 17, wherein assigning a link comprises incorporating a hyperlink into an online auction.

20. The method of claim 17, wherein negotiating one or more terms of a value exchange comprises accepting a highest bid in an online auction.

21. The method of claim 17, wherein subscribing to a service comprises providing user information and establishing an account with the exchange facilitator.
